(19) United States
(12) Patent Application Publication
(10) Pub. No.: US 2022/0051313 A1
(43) Pub. Date: Feb. 17, 2022

(54) Online Auction Computer Network System

(71) Applicants: Kurt Aumann, Nokomis, IL (US); Matt Corso, Nokomis, IL (US); Jeremy Piatt, Nokomis, IL (US); David Anderson, Taylorville, IL (US)

(72) Inventors: Kurt Aumann, Nokomis, IL (US); Matt Corso, Nokomis, IL (US); Jeremy Piatt, Nokomis, IL (US); David Anderson, Taylorville, IL (US)

(21) Appl. No.: 16/947,741

(22) Filed: Aug. 14, 2020

(51) Int. Cl. G06Q 30/08; H04N 7/15; G06Q 30/06

(52) U.S. Cl. CPC G06Q 30/08; G06Q 30/0643; H04N 7/15

(57) ABSTRACT

An online auction computer network system includes enhanced interactivity between users and an auctioneer. The system includes a webpage that shows a list of items to be auctioned, along with current bids on each item, the time remaining until the auction is over and bids will no longer be accepted. The computer server and processor may additionally provide a live stream audio and video feed of an auctioneer to the user computing device, as well as a chat box feature. The chat box feature allows users to communicate questions and comments solely to the auctioneer. Other users are prevented from viewing communications sent to the auctioneer through the chat box feature. The auctioneer may choose to answer the questions posed by the users through the chat box feature during his or her ongoing commentary.

Online auctions delivered to users via the Internet have become a popular activity for users interested in purchasing goods and services for the least possible amount online. Many online auctions allow a person to bid on an item, in an attempt to obtain a winning bid and an associated opportunity to purchase the auction item at the winning bid price. Many online auction websites allow online auction participants to compete against one another by submitting bids on a particular item until a predefined period of time has elapsed, and the highest bidder is determined.

Often, online auctions are conducted through websites where multiple items are being auctioned simultaneously. Bidders may place a bid on a particular item, and typically, the online auction websites have systems in place to notify the bidder if another bidder has placed a higher bid on that item, so that the bidder may bid again at a higher price before the auction closes.

Many online auction sites exist today, and various online auction systems have been developed to conduct online auctions so that the bidders may participate remotely, without the necessity of being present at a live auction. Some examples of such online auction systems that have been developed are disclosed in the following references, which are incorporated herein by reference, in their entireties:

U.S. Pat. No. 10,453,120 Networked Computer System and Computer Implemented Methods for Providing an Online Auction Webpage with Skill Based Game

A networked computer system for providing a webpage to a user is described herein. The networked computer system includes a database and a computer server that includes a processor that is coupled to a memory device. The database includes a webpage list including a plurality of host webpage records and an auction list including a plurality of auction items. The computer server receives a participation request from a web browser, accesses the database, and generates an auction webpage. The computer server receives a signal indicating a bid request from the user, generates a skill-based game to the user, receives a skill input from the user, determines an outcome of the skill-based game based on the skill input, and generates a bid associated with the received bid request based on the outcome of the skill-based game.

### U.S. Application No. 20120084169 Online Auction Optionally Including Multiple Sellers and Multiple Auctioneers

A server runs an application for defining and controlling an auction event of multiple items, wherein the application is configured to provide display information during the auction event to each of a plurality of computing devices to use in determining the contents of a graphical user interface (GUI) display on the computing device. The GUI includes visual representations of an auction host who defined the auction event, an auctioneer who is auctioning an item in the auction event, an item currently being auctioned, a showcase area, and a countdown indicator. The auction event may include a lobby phase and a live auction phase. During the lobby phase, the GUI may include visual representations of a first item to be auctioned, a plurality of participants in the lobby area, and a user, and the user may select to move the user's visual representation to a different location within the lobby area.

U.S. Application No. 20120084171 Option for Submitting a User-Defined Super Bod that Overrides an Auction Countdown

An application controls an online auction event. In the auction event, a user is provided a first selectable option for setting a bid value and a second selectable option for placing a bid at the bid value. A countdown value maintained by the server and provided to the computing device is set to an initial value at the beginning of the auction event, begins decreasing from the initial value according to a mathematical formula, and decreases to a final value at the end of the auction event. If the application receives a bid from the computing device during the auction event as a result of a user selecting the second selectable option and the application determines that the bid is a super bid, the application overrides the mathematical formula and adjusts the countdown value to a new value.

### U.S. Application No. 20130262257 System and Method for Facilitating Sales Transactions

A system and method for facilitating an on-line fee based auction of an item is provided. The item has a predetermined pre-funding requirement amount that needs to be satisfied for the item to become a live auction item. Users may fund the item, which will count toward satisfying the pre-funding requirement amount of the item. For funding the item, the users are provided with a number of bid credits corresponding to their funding amount, which can be used by the users in bidding on any of the live auction items. Each of the live auction items are associated with an independent countdown timer indicative of the time remaining until the end of the auction, and each bid placed by the users adjusts the countdown timer.

### U.S. Application No. 20130304599 Method and System of Conducting Interactive Online Auctions

An application controls an online auction event. In the auction event, a user is provided a first selectable option for setting a bid value and a second selectable option for placing a bid at the bid value. A countdown value maintained by the server and provided to the computing device is set to an initial value at the beginning of the auction event, begins decreasing from the initial value according to a mathematical formula, and decreases to a final value at the end of the auction event. If the application receives a bid from the computing device during the auction event as a result of a user selecting the second selectable option and the application determines that the bid is a super bid, the application overrides the mathematical formula and adjusts the countdown value to a new value.

### U.S. Application No. 20140279164 Virtual Online Auction Forum

A method and system for auctioning an item over a network inside a virtual auction forum populated by graphical representations of users is described. Virtual profiles containing graphical representations are associated with each of the users of an auction forum, and the auction for the item is virtualized. The users of the auction forum participate as bidders in the virtual auction with their graphical representations, and some events in the virtual auction are represented through the users' graphical representations.

### U.S. Application No. 20150006312 System and Method for Conducting an Online Auction

In one implementation, an online auction for a cohort of users that have a pre-established association with a scheduled experience may be provided. The cohort associated with the scheduled experience may be determined. The cohort may comprise a plurality of users that have a pre-established association with the scheduled experience. Auction information related to an auction for one or more items may be received. One or more users of the cohort may be associated as participants of the auction. The auction may be conducted for the one or more items.

U.S. Pat. No. 7,797,222 Method and Apparatus for Holding an Online Live Auction to Combine Features of Both the Internet and Traditional, Real World Auctions

A method and apparatus are provided for conducting a live auction that combines various features of traditional and online auctions. According to one aspect of the present invention, the live auction includes a live, in-person auction component and a real-time online bidding environment component. Bidding information associated with an item in the online bidding environment is updated to reflect a current bid associated with the item in the live, in-person auction. During the live, in-person auction, a bid is be accepted from an online bidder in the online environment that reflects the online bidder's bid price for the item. Subsequently, the system bids on behalf of the online bidder against other online bidders as well as one or more live bidders that are participating in the live, in-person. As such, the live auction enables real-time online bidding in a live, in-person auction.

U.S. Pat. No. 9,037,497 Live Auction Participation Utilizing a Coupled Bidding Device

The ability to participate in an active auction is enabled for remote bidders by allowing the remote bidder to use a bidding device coupled to an active auction through a network. The remote bidding device receives live audio from the auction with minimal delay, and can receive and provide bidding information to the auction in real time. As such, the remote bidder can participate with equal standing as local participants.

U.S. Pat. No. 9,996,875 Online Bidding System

A method and computer program product is provided for an online bidding system. The method may include receiving a plurality of bids from a plurality of online bidding communities during a live auction event at one of a primary technology provider and a relying technology provider, wherein the live auction event simultaneously occurs on a physical auction floor and virtually. The method may also include processing the plurality of bids at the primary technology provider. The method may further include providing the processed plurality of bids to a single designated clerking console associated with the primary technology provider for the live auction event. The method may also include receiving an accepted bid from the single designated clerking console.

### WO Number 2017139836 Auction Systems and Methods

A method for conducting of an auction that caters to both on-site physical bidding and online bidding. An auction server communicates with computing devices registered for the auction and a content file server across a network. The auction server application is receiving a request from one of the plurality of computing device and determining a request type of the request. The method further comprising responsive to determining that the request is a request to accept a proposed bid and that the proposed bid is acceptable, determining an updated current increment value based on a comparison of the proposed bid and a current bid for the auction, storing the updated current increment value as the current increment value; storing the acceptable proposed bid as the current bid, and transmitting the updated current increment value and current bid to the content file server for broadcasting to some of the computing devices.

In a live auction, the auction floor is typically an exciting and emotionally charged environment. Whether the auction is focused on selling automobiles, items of fine art, construction equipment or the like, there is nothing that compares to standing in the crowd of bidders, listing to the chatter of the auctioneers, the cheers and the shouts of the bidders. In addition, the auction floor allows for the potential bidders to inspect the vast array of products to be auctioned by kicking the tires of an automobile, feeling the smoothness of a precious vase, listening to the roar of a diesel engine and otherwise developing a fondness for the object of their bidding efforts. However, in today's fast paced world, the advantages of participating in a live auction from a remote location are exceedingly evident.

None of the references mentioned above include a live-streaming feature wherein a live auctioneer offers ongoing, real-time commentary on multiple auction items that are being auctioned simultaneously. Additionally, none of the references cited above include a chat feature that allows bidders and auction participants to type a question into the online auction system, wherein the questions are communicated only to the auctioneer, who may provide answers to those questions and other commentary via the live streaming feature.

### SUMMARY OF THE INVENTION

The present invention is generally directed to networked computer systems and computer implemented methods for generating and providing online auction webpages to users.

In one aspect of the invention, a networked computer system for providing a webpage to a user via the Internet is provided. The system includes a database and a computer server that includes a processor that is coupled to a memory device. The database includes a webpage list including a plurality of host webpage data records and an auction list including a plurality of auction items. The processor is programmed to display an online auction including generating and displaying an auction webpage on the user computing device via the web browser. The auction webpage includes a plurality of auction items. The processor receives from the web browser a signal indicating a bid request from the user including a selected auction item and a bid unit.

The computer server and processor may additionally be used to provide a live stream audio and video feed of an auctioneer to the user computing device, as well as a chat box feature. The live audio/video feed allows a user to view an auctioneer who may provide commentary on the auction in real time. The auctioneer may discuss various auction items, provide information regarding those auction items, and offer commentary on bids for specific items as they are received from the bidders in real time. The chat box feature allows users (bidders and auction participants) to communicate questions and comments solely to the auctioneer. Other users are prevented from viewing communications sent to the auctioneer through the chat box feature. The auctioneer may choose to answer the questions posed by the users through the chat box feature during his or her ongoing commentary. In other words, users may use the chat box to send text questions directly to the auctioneer (and only to the auctioneer, but not to other users), and subsequently, the auctioneer may choose to answer those questions as part of the auctioneer's live-streamed real-time audio/video commentary that is broadcast to all participants through the users' web browsers.

### BRIEF DESCRIPTION OF THE DRAWINGS

These and other features, aspects, and advantages of the present invention will become better understood with regard to the following description, appended claims, and accompanying drawings where:

FIG. 1 is a simulated screenshot of one embodiment of the present invention, showing a webpage having a list of items to be auctioned, a time indicator showing how much time is left for users to make a bid, the amount of the current bid price for each item, an asking bid, and an inset video box showing an auctioneer providing ongoing commentary on the auction;

FIG. 2 is a simulated screenshot of one embodiment of the present invention, showing a webpage having a list of items to be auctioned, a time indicator showing how much time is left for users to make a bid, the amount of the current bid price for each item, an asking bid, and an inset video box showing an auctioneer providing ongoing commentary on the auction, and an inset chat box where users may send text questions and comments directly to the auctioneer.

### DETAILED DESCRIPTION OF THE INVENTION

Overview

The present invention includes, in a first embodiment, an online auction computer network system that provides a unique user experience, and includes enhanced interactivity between users (bidders and auction participants) and an auctioneer. The system includes a webpage that shows a list of items to be auctioned, along with current bids on each item, the time remaining until the auction is over and bids will no longer be accepted.

Additionally, because bidders and auction participants tend to enjoy the interplay between themselves and the auctioneer, the system provides an auction website having a screen that includes, among other information, a list of items to be auctioned 12, a time indicator 14 showing how much time is left for users to make a bid, the amount of the current bid price 16 for each item, an asking bid price 18. Additionally, an inset auctioneer box 20 that includes a real-time live-stream audio/video feed of an auctioneer who offers commentary on the auction, the latest bids on particular items, and other information about auction-related topics. Unlike a live auction, where the auctioneer takes bids on one item at a time until there are no higher bids, in this format, the auction includes a plurality of items being auctioned at the same time, and online bidders may make bids on any or all items simultaneously. In the present case, the auctioneer provides commentary on items of interest to the bidders in real time. If a “bidding war” heats up between multiple bidders for a particular item, the auctioneer may focus on that item and attempt to solicit additional bids for that item.

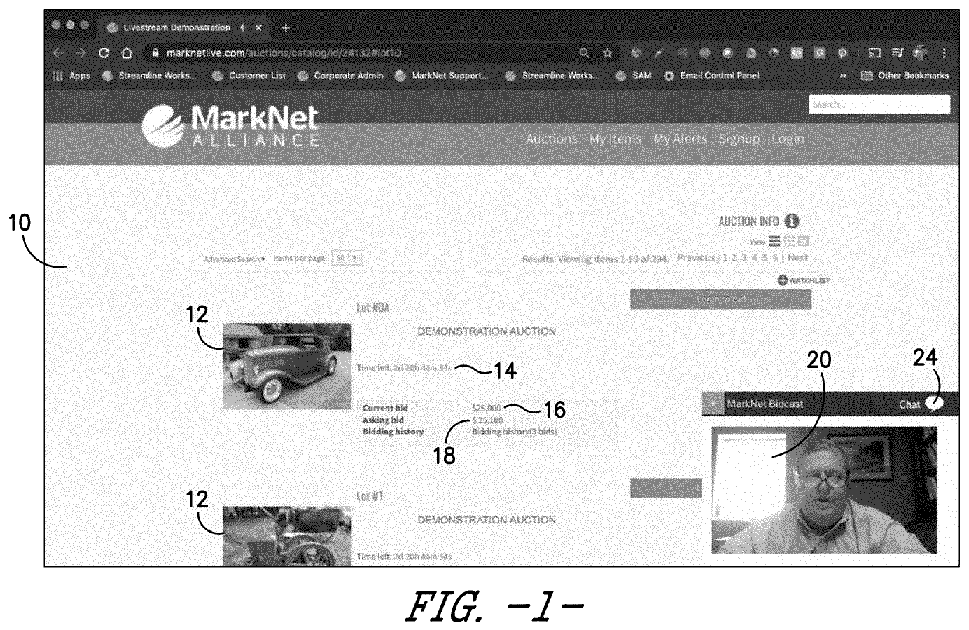

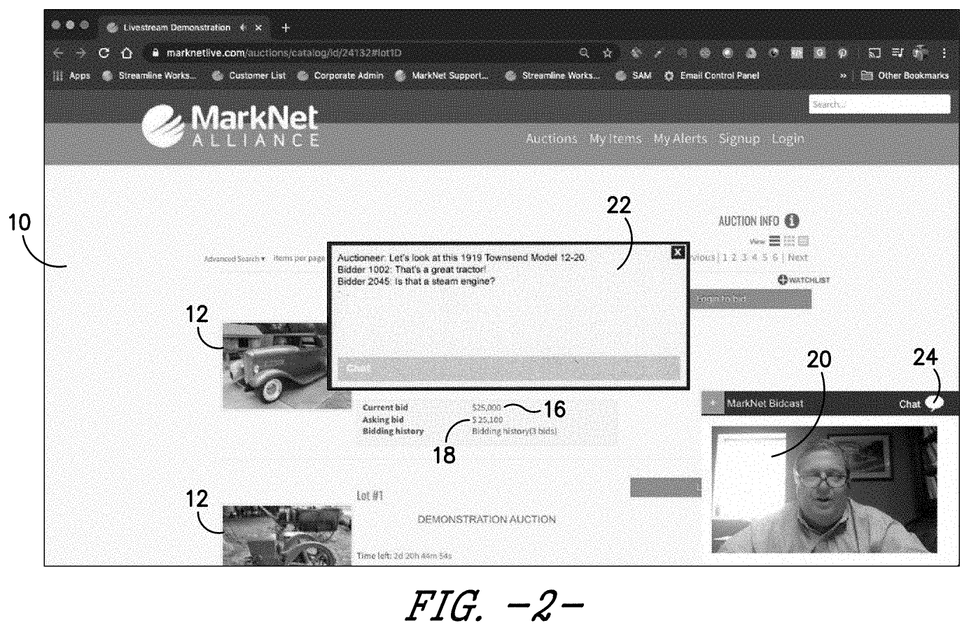

Another feature that enhances the interplay between the auctioneer and the users is a chat box 22 that is provided on the webpage, wherein the users may write text questions or comments to send to the auctioneer. In one embodiment, the inset auctioneer box 20 with the live audio/video feed of the auctioneer includes a chat icon 24 along a top bar thereon, as shown in FIG. 1. When an auction participant clicks the chat icon 24, then the chat box 22 (also referred herein as a “text box”) appears, as shown in FIG. 2.

When an auction participant submits a question through the text box 22, the other bidders do not see the questions that are sent to the auctioneer, and the auctioneer may choose to answer the questions, provide information on items based on the questions, or simply ignore the questions if he believes that the question is not relevant, or that the answer to the question would not be of interest to the bidders at large. This system allows the auctioneer to filter through the text messages sent by bidders. The auctioneer may point out items that still have a low bid price currently, in order to draw the attention of bidders to an item that he believes is a good deal, is underpriced, or has simply gone unnoticed. In this way, the auctioneer works multiple items at one time, and conducts the auction as he sees fit, in order to provide timely information, entertainment, and to answer bidder questions in real time as the auction progresses.

Typically, in order to participate in the auction, bidders will set up an account through the webpage, to include their shipping address to receive items they have won in the auction, their names, other contact information such as a phone number, email address, etc., and a method of payment such as a credit card, debit card, or the like. Optionally, the webpage may identify bidders, either directly by name, or by a moniker chosen by the bidders themselves, so that bidders know whether they are bidding against one other bidder or multiple bidders on a particular item during the auction.

As with many online auctions, there may be a time limit for submitting bids on items, and after the deadline has expired, no further bids are accepted. At that point, the highest bid for each item wins, and that bidder is charged for the item, which is then shipped to the bidder. In one embodiment, if a bid is received during some set time period at the end of the auction (the last five minutes, for instance), then the system may extend the bidding time on that particular item for another set time period (another five minutes, for example), in order to give bidders additional time to place higher bids on that item. This arrangement prevents a wily bidder from submitting a bid with only a few seconds left in the auction, thereby preventing other bidders from submitting a higher bid. In this situation, each “overtime” bid resets the deadline clock, and the bidding does not end until there have been no higher bids submitted for that particular item for at least the pre-set time extension period (again, if no further bids were received for the last five minutes, for example).

In the preferred embodiment, the steps of the present invention are embodied in machine-executable instructions. The instructions can be used to cause a general purpose or special-purpose processor that is programmed with the instructions to perform the steps of the present invention. Alternatively, the steps of the present invention might be performed by specific hardware components that contain hardwired logic for performing the steps, or by any combination of programmed computer components and custom hardware components.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or any other suitable type of media/machine-readable medium suitable for storing electronic instructions. Moreover, the present invention may also be downloaded as a computer program product or application (“app”), wherein the program may be transferred from a remote computer (e.g., a server) to a requesting computer (e.g., a client) by way of data signals embodied in a carrier wave or other propagation medium via a communication link (e.g., a modem or network connection).

Client-Server Environment

The architecture of the Internet-based system follows a conventional client-server model. The terms “client” and “server” are used to refer to a computer's general role as a requester of data (the client) or provider of data (the server). Internet clients and servers communicate using a protocol such as HyperText Transfer Protocol (HTTP). In the Web environment, Web browsers reside on clients and render Web documents (pages) served by the Web servers. The client-server model is used to communicate information between clients and servers. Servers are coupled to the Internet and respond to document requests and/or other queries from clients. When a user selects a document by submitting its Uniform Resource Locator (URL), a Web browser, such as Safari or Google Chrome, opens a connection to a server and initiates a request (e.g., an HTTP get) for the document. The server 110 delivers the requested document, typically in the form of a text document coded in a standard markup language such as HyperText Markup Language (HTML).

### Exemplary Online Auctioning Site Interface

FIGS. 1 and 2 show an exemplary online auction site screen providing online bidders an interface to participate in an online auction with a live-streaming auctioneer. The web page provides a listing of all items available in the auction in which the online user may bid. The online user may click hyperlinks for each item, which then takes the user to various screens that will allow the user to search and view items, watch and listen to the auctioneer providing commentary about the ongoing auction and auction items, and submit real-time bids in the auction.

According to one embodiment, when an online bidder makes a request to search and view a catalog for items available in the auction, the auction screen is presented with a textual list of items. In this example, each item includes a hypertext link having a picture of the item, a title, a brief description, a high/low estimate and a starting price. Responsive to the selection of the hypertext link, a subsequent screen displays the item and allows the online user to enter a bid for the item.

According to one embodiment, when an online bidder makes a request to participate in the auction, the user is directed to a real-time event screen 10. The real time event screen 10 is automatically updated to reflect the current lot on sale and may also include the name of the seller and the item. As described herein, a lot refers to one item or a group of items 12 that will be auctioned together as part of a sale. The screen may also include the following: a lot number, a lot picture, current price, current high bidder, bid button for automatic bids, bid box for bids above the current price, amount of absentee bid previously placed by any user, on/off button for live webcasts, a promotional message, link to the corrigenda (announcements), titles of next three supporting lots, and the current time.

The inset auctioneer box 20 enables online bidders to view and listen to the auctioneer conducting the auction. Depending on the option the online bidder selects an audio or audio/video stream is sent to the online bidder's computer, in the form of the inset auctioneer box 20. The stream is originated at the auction house and generally captures the auctioneer's actions. Implementation details regarding video and audio streaming over the Internet are known to those skilled in the art and are therefore not provided herein.

The auctioneer box 20 may be a separate window that provides the live feed of the auctioneer making commentary about the auction. In one embodiment, the auctioneer box 20 may be moved around the screen by clicking and dragging it to any desired location on the screen. Additionally, the auctioneer box 20 may be programmed to remain visible even when a bidder or user is clicking on various items on the auction webpage or website, so that the bidder may always have the audio/video feed on the screen, while looking clicking around to look at various items, bid prices, or other information on the auction web site.

Similarly, in one embodiment, the chat box may also be moved around the screen by clicking and dragging it to any desired location, and further, may be programmed to remain visible while the user is viewing various parts of the auction website.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A system that enables an individual to remotely participate in an active auction over a network using a processing device, the system comprising:
a processor configure to:
receive auction bids from the processing device of the individual for an item that is being auctioned;
receive the entry of bid information from the one or more other entities; and
transmit bid status information toward the processing device of the individual;
an audio/video system coupled to the network, the audio system configured to:
capture live audio of an auctioneer in real-time during said auction; and
transmit the live audio and video over the network towards the processing device.

2. The system set forth in claim 1, wherein said processor is further configured to receive entries of bid information for multiple auction items simultaneously.

3. The system set forth in claim 1, wherein said processor is further configured to receive text messages from said individual and display said text messages to said auctioneer so that other entities are prevented from viewing said text messages.

4. The system set forth in claim 1, wherein said processor is further configured to end said auction at a specified time.

5. The system set forth in claim 4, wherein said processor is further configured to extend said auction for a first preset time period if a bid is received within a second preset time period before said auction is scheduled to end.

6. The system set forth in claim 1, wherein said processor is further configured to send a notification to said individual to notify said individual that another entity has submitted a higher bid than said individual's latest bid on a specific auction item.
